(19) United States
(12) Patent Application Publication
(10) Pub. No.: US 2026/0336637 A1
(43) Pub. Date: Oct. 29, 2026

(54) TRAINING MULTI-MODAL NEURAL NETWORKS FOR MOTION PLANNING THROUGH REINFORCEMENT LEARNING

(71) Applicant: Waymo LLC, Mountain View, CA (US)

(72) Inventors: Yiren Lu, Santa Clara, CA (US); Letian Chen, Bellevue, WA (US); Justin Junxuan Fu, San Francisco, CA (US)

(21) Appl. No.: 19/663,166

(22) Filed: Apr. 29, 2026

Related U.S. Application Data
(60) Provisional application No. 63/797,034, filed on Apr. 29, 2025.

(51) Int. Cl. B60W 50/00; B60W 60/00; G05B 13/02; G06N 3/092

(52) U.S. Cl. CPC B60W 50/0097; B60W 50/0098; B60W 60/0013; B60W 60/0015; G05B 13/027; G06N 3/092; B60W 2050/0028; B60W 2420/403; B60W 2420/408; B60W 2420/54; B60W 2555/60

(57) ABSTRACT

Methods, systems, and apparatus, including computer programs encoded on a computer storage medium, for training a multi-modal neural network that generates motion plans for vehicles. In particular, the multi-modal neural network is trained through reinforcement learning.

### CROSS-REFERENCE TO RELATED APPLICATION

This application claims priority to U.S. Provisional Application No. 63/797,034, filed on Apr. 29, 2025. The disclosure of the prior application is considered part of and is incorporated by reference in the disclosure of this application.

### BACKGROUND

This specification relates to planning the future trajectory of an autonomous vehicle in an environment.

The environment may be a real-world environment, and the autonomous vehicle can be, e.g., an automobile in the environment.

Autonomous vehicles include fully autonomous driverless cars, boats, and aircraft. Autonomous vehicles use a variety of on-board sensors and computer systems to detect nearby objects and use such detections to make control and navigation decisions.

### SUMMARY

This specification describes a system implemented as computer programs on one or more computers in one or more locations that trains a multi-modal neural network that performs motion planning through reinforcement learning. That is, during this training, the system can process the input using the multi-modal neural network to generate an output sequence of tokens. The system can then generate, from the output sequence of tokens, trajectory data defining a planned trajectory for the first vehicle after the first time point and apply a reward function to the trajectory data to determine a respective reward for each of a plurality of tokens in the output sequence. The system then trains the multi-modal neural network using the respective rewards for the plurality of tokens through reinforcement learning.

In general, one innovative aspect of the subject matter described in this specification can be embodied in methods that include the actions of: obtaining data characterizing a scene in an environment being navigated by a first vehicle at a first time point; generating, from the data characterizing the scene, an input to a multi-modal neural network; processing the input using the multi-modal neural network to generate an output sequence of tokens; generating, from the output sequence of tokens, trajectory data defining a planned trajectory for the first vehicle after the first time point; applying a reward function to the trajectory data to determine a respective reward for each of a plurality of tokens in the output sequence; and training the multi-modal neural network using the respective rewards for the plurality of tokens through reinforcement learning.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system.

FIG. 2 is a flow diagram of an example process for training the multi-modal neural network.

FIG. 3 is a diagram showing the training process.

FIG. 4 shows an example of the rewards used by the described techniques relative to those used by other approaches.

Like reference numbers and designations in the various drawings indicate like elements.

### DETAILED DESCRIPTION

This specification describes a system implemented as computer programs on one or more computers in one or more locations that trains a multi-modal neural network that performs motion planning through reinforcement learning.

Multi-modal neural networks, e.g., Multimodal Large Language Models (MLLMs), have demonstrated significant advancements on tasks that require multi-modal (e.g. visual) comprehension and semantic understanding. Leveraging their ability to process both visual and textual inputs, multi-modal neural networks can be adapted through Supervised Fine-Tuning (SFT) for a wide range of applications, including visual question answering, video captioning, medical image analysis, and robotics. While multi-modal neural networks excel in tasks with well-defined answers, their application to motion planning for autonomous vehicles—a domain that demands an understanding of complex scenes, coherent trajectory planning, and decision-making in uncertain environments—remains a challenge. Vehicle motion planning introduces unique challenges that go beyond traditional visual comprehension tasks. Unlike perception, planning requires generating structured sequences that reflect task-specific constraints and preferences. Despite the potential of multi-modal neural networks, the standard SFT paradigm of optimizing next-token prediction may fall short on such tasks, as it only encourages imitation of surface-level token distributions observed in the training data, without regard for whether the resulting trajectories are physically feasible, comfortable, or efficient.

The techniques described address these issues by training a multi-modal neural network that performs motion planning through reinforcement learning. In contrast to SFT, reinforcement learning is well-suited towards optimizing task-specific objectives, and has been shown to be effective in guiding models toward performance goals. More specifically, the described approach combines the semantic understanding and common-sense reasoning capabilities of multi-modal neural networks with the policy optimization strengths of RL to meet the challenging demands of autonomous vehicle planning. For example, the described techniques can implement a training pipeline that leverages the ability of a pre-trained multi-modal neural network to interpret a wide distribution of scenarios from extensive pre-training, establishes a strong baseline with plan trajectories as text sequences of X-Y coordinates via a supervised fine-tuning (SFT) phase, and then enhances the ability to produce cost-aware plans via an RL fine-tuning (RLFT) phase. The SFT phase reduces the exploration space for the RLFT stage, allowing effective targeted improvements in planning objectives with a relatively small amount of compute (e.g., the RLFT phase can require less than 5% of SFT training steps in order to achieve significant improvement). In particular, the described techniques transform the multi-modal neural network's output text token sequence into a trajectory representation, enabling a planning reward calculation based on trajectory quality on a per-token basis. Moreover, the described techniques are compatible with non-differentiable rewards, allowing them to optimize arbitrary task-specific rewards that improve final end-to-end planning performance.

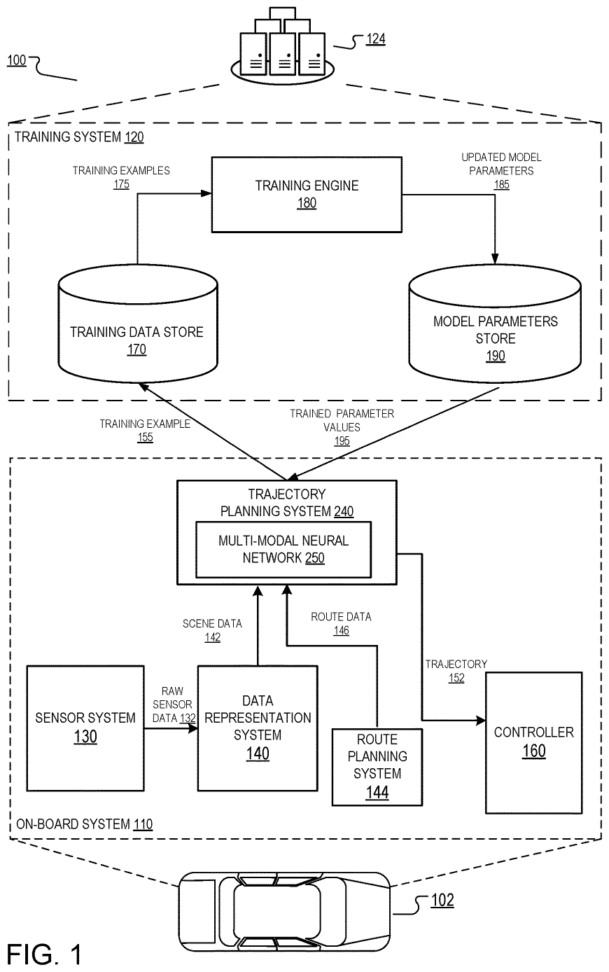

FIG. 1 shows an example system 100. The system 100 is an example of a system implemented as computer programs on one or more computers in one or more locations in which the systems, components, and techniques described below are implemented. The system 100 includes an on-board system 110 and a training system 120.

The on-board system 120 is physically located on-board a vehicle 102. Being on-board the vehicle 102 means that the on-board system 110 includes components that travel along with the vehicle 102, e.g., power supplies, computing hardware, and sensors. In some cases, the vehicle 102 is an autonomous vehicle. An autonomous vehicle can be a fully autonomous vehicle that determines and executes fully-autonomous driving decisions in order to navigate through an environment. An autonomous vehicle can also be a semi-autonomous vehicle that uses predictions to aid a human driver. For example, the vehicle 102 can autonomously apply the brakes if a prediction indicates that a human driver is about to collide with another vehicle.

As another example, the vehicle 102 can have an advanced driver assistance system (ADAS) that assists a human driver of the vehicle 102 in driving the vehicle 102 by detecting potentially unsafe situations and alerting the human driver or otherwise responding to the unsafe situation. As a particular example, the vehicle 102 can alert the driver of the vehicle 102 or take an autonomous driving action when an obstacle is detected, when the vehicle departs from a driving lane, or when an object is detected in a blind spot of the human driver.

The on-board system 110 includes one or more sensor subsystems 130. The sensor subsystems 130 include a combination of components that receive reflections of electromagnetic radiation, e.g., lidar systems that detect reflections of laser light, radar systems that detect reflections of radio waves, and camera systems that detect reflections of visible light.

The sensor data generated by a given sensor generally indicates a distance, a direction, and an intensity of reflected radiation. For example, a sensor can transmit one or more pulses of electromagnetic radiation in a particular direction and can measure the intensity of any reflections as well as the time that the reflection was received. A distance can be computed by determining how long it took between a pulse and its corresponding reflection. The sensor can continually sweep a particular space in angle, azimuth, or both. Sweeping in azimuth, for example, can allow a sensor to detect multiple objects along the same line of sight.

The sensor subsystems 130 or other components of the vehicle 102 can also classify groups of one or more raw sensor measurements from one or more sensors as being measures of another agent. A group of sensor measurements can be represented in any of a variety of ways, depending on the kinds of sensor measurements that are being captured. For example, each group of raw laser sensor measurements can be represented as a three-dimensional point cloud, with each point having an intensity and a position in a particular two-dimensional or three-dimensional coordinate space. In some implementations, the position is represented as a range and elevation pair. Each group of camera sensor measurements can be represented as an image patch, e.g., an RGB image patch.

Once the sensor subsystems 130 classify one or more groups of raw sensor measurements as being measures of respective other agents, the sensor subsystems 130 can compile the raw sensor measurements into a set of raw data 132, and send the raw data 132 to a data representation system 140.

The data representation system 140, also on-board the vehicle 102, receives the raw sensor data 132 from the sensor system 130 and generates scene data 142. The scene data 142 characterizes the current state of the environment surrounding the vehicle 102 as of the current time point.

For example, the scene data can characterize, for one or more agents, e.g., other vehicles, pedestrians, cyclists, etc., in the environment, a current state at the current time point and a previous state at one or more respective previous time points. In other words, the scene data can include, for one or more agents in the environment, data that characterizes a previous trajectory of the agent in the environment up to the current time point. The state of an agent at a time point can include the location of the agent at the time point and, optionally, values for a predetermined set of motion parameters at the time point. As a particular example, the motion parameters can include a heading for the agent, a velocity of the agent, and/or an acceleration of the agent. In another example, one or more agents in the environment can be represented jointly, e.g., by a state describing the position, dimensions, and velocity of the joint representation (e.g., the position, velocity, and horizontal dimensions of a crowd of pedestrians).

In some implementations, the scene data also includes data characterizing a current state of the autonomous vehicle at the current time point and a previous state of the autonomous vehicle at one or more respective previous time points.

In some implementations, the scene data also includes data characterizing features of the environment. These features can include (i) dynamic features of the environment, e.g., traffic light states at the current time point, (ii) static features of the environment, e.g., roadgraph data characterizing one or more of lane connectivity, lane type, stop lines, speed limits, and so on, of roadways in the vicinity of the autonomous vehicle or (iii) both. In one example, the dynamic features of the environment can be represented by a combination of polylines (e.g., for the position of the feature) and one-hot encoding vectors (e.g., one-hot encodings for the red-yellow-green lights of a traffic light, with polylines representing the position in the environment). The static features of the environment can be represented by polylines. For features represented by polylines, the features can be converted to feature vectors (e.g., represented by x, y points with vector directions in the environment, such as numerical values representing x, y positions and a heading) prior to the system using them.

The data representation system 140 provides the scene data 142 to a trajectory planning system 240, also on-board the vehicle 102.

In some cases, a route planning system 144 also provides route data 146 to the trajectory planning system 240.

The route data 146 is an output generated by the route planning system 144 that characterizes how the autonomous vehicle should navigate in a future time window in order to follow a designated route.

For example, the route data 146 can reflect a determination by the planning system 144 that the autonomous vehicle should follow a route characterized by the route data 146 in order to satisfy certain criteria.

The route characterized by the route data 146 can be, e.g., a high level intended route for the autonomous agent embedded in the roadgraph for the environment with no notion of time.

The certain criteria can include one or more of, e.g., a set of one or more traffic laws (e.g., speed limit, right of way, lane traversal, etc.), a set of one or more safety regulations (e.g., minimum following distances, adjustments to speed given weather conditions, etc.), or a set of one or more goal criteria (e.g., an intended destination, minimum deviation from a template path when confronted with dynamic road conditions, etc.).

The route data 146 can be represented in any of a variety of ways.

For example, the route data 146 can be represented by, e.g., an ordered set of points with vector directions for the intended route (e.g., x, y positions with vector directions). Each point can represent a waypoint spatial location in a sequence of waypoint spatial locations for the autonomous vehicle to follow to reach an intended destination, e.g., a sequence of evenly-spaced waypoint spatial locations that are each constrained to fall on a feature that is present in the roadgraph, e.g., to fall on a path that is represented in the roadgraph, e.g., a path that traverses the center of any given driving lane.

As another example, the route data 146 can be represented as a natural language description of the route to be traversed.

As yet another example, the route data 146 can be represented as a sequence of one or more vectors, each of which identifies a driving maneuver (go straight, turn left, reverse, stop, and so on).

The trajectory planning system 240 processes the scene data 142 and the route data 146 to generate a final planned trajectory 152. The final planned trajectory 152 characterizes the future trajectory of the autonomous vehicle after the current time point.

The trajectory planning system 240 then provides the final planned trajectory 152 to a controller 160 of the autonomous vehicle 102.

The controller 160 is hardware or software or a combination of hardware and software on-board the autonomous vehicle 102 that controls the autonomous vehicle 102. That is, the controller 160 submits inputs to the various control systems of the autonomous vehicle 102, e.g., the braking system, the steering system, the throttle system, and so on, in order to control the movement of the autonomous vehicle 102 in the environment.

Thus, the controller 160 maps the final planned trajectory 152 to a sequence of controls for the control systems of the vehicle 102 and submits the controls to the control systems to control the vehicle 102.

For example, the controller 160 can submit the control inputs to the control systems at the corresponding time points until a new planned trajectory is received or until a signal is received from another component of the on-board system 110 that indicates that the controller 160 should stop controlling the vehicle 102 using the final trajectory 152.

To generate the final trajectory 152, the system 240 uses a multi-modal neural network 250.

The multi-modal neural network 250 is a neural network that is configured to process an input generated from the scene data 142 and, optionally, the route data 146 to generate, as output, a set of one or more candidate planned trajectories 144 for the vehicle 102. The neural network 250 is described as a “multi-modal” neural network because the neural network is configured to process multiple modalities of input data, e.g., both image and text data.

The system 240 then generates the final trajectory 152 using the candidate planned trajectories 144 generated by the prediction neural network.

For example, the system 240 can generate the final trajectory 152 by selecting one of the candidate planned trajectories 144 and, optionally, post-processing the selected candidate planned trajectory 144. Generally, the system 240 can generate the final trajectory 152 by applying a set of rules, e.g., machine-learned rules, fixed rules, or a combination of both to the candidate planned trajectories 144.

The multi-modal neural network and generating the final trajectory 152 are described in more detail below.

In some implementations, the on-board system 110 uses the control system 240 to control the vehicle throughout the operation of the vehicle 102 in the environment. In some other implementations, the on-board system 110 uses the control system 240 to control the vehicle only in certain driving scenarios and, in other driving scenarios, uses one or more other on-board systems to generate the inputs to the controller 160. As a particular example, the on-board system 110 can use the control system 200 for freeway or highway driving scenarios while using different control systems for navigating surface streets. As another particular example, the on-board system 110 can use the control system 240 for night-time driving scenarios while using different control systems for daytime driving scenarios.

To generate the trajectory 152, the trajectory planning system 240 can use trained parameter values 195, i.e., trained model parameter values of the multi-modal neural network 250, obtained from a trajectory planning model parameters store 190 in a training system 120. The training system 120 is typically hosted within a data center 124, which can be a distributed computing system having hundreds or thousands of computers in one or more locations.

As will be described in more detail below, the training system 120 can train the multi-modal neural network 250 through reinforcement learning. Optionally, prior to the reinforcement learning training, the training system 120 or another training system can train the multi-modal neural network 250 on one or more “pre-training tasks.” Examples of pre-training tasks include unsupervised next token prediction tasks, instructing tuning tasks, supervised fine-tuning tasks, and so on.

The training system 120 includes a training data store 170 that stores the training data used to train the trajectory planning system i.e., to determine the trained parameter values 195 of the trajectory planning system 240. The training data store 170 receives raw training examples from agents operating in the real world. For example, the training data store 170 can receive a raw training example 155 from an agent, e.g., a manually driven vehicle or autonomous vehicle controlled using a different planning system. The raw training example 155 can be processed by the training system 120 to generate a new training example. The raw training example 155 can include scene data and route data, e.g., like the scene data 142 and route data 146, that can be used as input for a new training example. The raw training example 155 can also include outcome data characterizing the state of the environment surrounding the autonomous vehicle 102 at the one or more future time points. This outcome data can be used to generate a ground truth trajectory for the autonomous vehicle at the time point characterized by the scene data and ground truth trajectories for the other, target agents in the scene at the time point. The ground truth trajectory for a given agent, i.e., a target agent or the autonomous vehicle, identifies the actual trajectory (as derived from the outcome data) traversed by the agent at the future time points. For example, the ground truth trajectory can identify spatial locations in an autonomous vehicle-centric coordinate system to which the agent moved at each of multiple future time points. The ground truth trajectory can be used, e.g., during supervised fine-tuning of the multi-modal neural network 250.

The training data store 170 provides training examples 175 to a training engine 180, also hosted in the training system 120. The training engine 180 uses the training examples 175 to update the model parameters of the multi-modal neural network 250, and provides the updated model parameters 185 to the trajectory planning model parameters store 190. Once the parameter values of the multi-modal neural network 250 have been fully trained, the training system 120 can send the trained parameter values 195 to the trajectory planning system 240, e.g., through a wired or wireless connection.

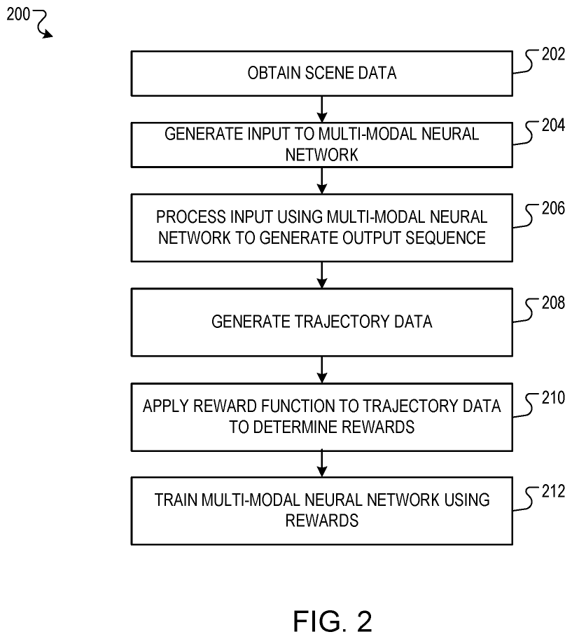

FIG. 2 is a flow diagram of an example process 200 for training the multi-modal neural network. For convenience, the process 200 will be described as being performed by a system of one or more computers located in one or more locations. For example, a training system, e.g., the training system 200 of FIG. 1, appropriately programmed in accordance with this specification, can perform the process 200.

In particular, the process 200 is an example of a process for training the multi-modal neural network through reinforcement learning.

In some cases, prior to the training of the multi-modal neural network through reinforcement learning, the multi-modal neural network has already been trained, e.g., on one or more “pre-training tasks.” Examples of pre-training tasks include unsupervised next token prediction tasks, instructing tuning tasks, supervised fine-tuning tasks, and so on. That is, in these cases the system “fine-tunes” the multi-modal neural network through reinforcement learning to improve the performance of the multi-modal neural network on the motion planning task.

As a particular example, the system or another training system can have pre-trained the multi-modal neural network on a large data set of general purpose multi-modal data to cause the multi-modal neural network to learn to interpret a wide distribution of scenarios. The system or the other training system can then perform supervised fine-tuning on a motion planning data set to establish a strong baseline performance level on the motion planning task. The system can then train the multi-modal neural network through reinforcement learning to further improve the performance of the neural network.

As part of the reinforcement learning training, the system obtains scene data characterizing a scene in an environment being navigated by a first vehicle at a first time point (step 202).

The data characterizing the scene can include any of a variety of types of information about the scene in the environment. For example, the data characterizing the scene can include sensor data, e.g., data captured by one or more sensors of the first vehicle. As a particular example, the sensor data can include one or more of image data, LiDAR data, radar data, or audio data. As another example, the data characterizing the scene can include road graph data.

As another example, the data characterizing the scene comprises data characterizing other agents in the scene, e.g., data characterizing current and past states of other agents, e.g., vehicles, cyclists, pedestrians, and so on, in the scene. As another example, the data characterizing the scene can include text data describing the scene, describing the motion planning task, or both.

More generally, however, the data characterizing the scene is multi-modal data that includes data of multiple modalities, e.g., both image and text data. For example, the data characterizing the scene can include two or more of: text data, image data, LiDAR data, radar data, or audio data.

As a particular example, the data characterizing the scene can include (i) an image that represents the road graph data and data about the first vehicle and other agents and (ii) text that describes the motion planning task (“generate a trajectory in the vehicle coordinate system for the next 8 seconds”) and, optionally, that includes additional information about the scene. For example, the additional information about the scene can include information about the first vehicle, e.g., one or more of the position, velocity, or acceleration of the first vehicle over a most-recent time interval. As another example, the additional information can include information about the intended route for the first vehicle, e.g., waypoint locations along the intended route of the vehicle represented as (x,y) coordinate pairs or a natural language description of the intended route.

As a particular example, the system can generate a rasterized image that represents the road graph data and data about the first vehicle and other agents. For example, the system generates the image by rasterizing the roadgraph and past trajectories into a 3-channel (RGB) image. Each channel conveys distinct scene elements: For example, one channel, e.g., the Red channel, can represent the roadgraph, including lane boundaries and other road features. As another example, another channel, e.g., the Green channel, can encode the past trajectory of the first vehicle. As another example, another channel, e.g., the Blue channel, can encode the past trajectories of other vehicles in the scene. When generating the image, the system can transform all coordinates of all spatial locations to center the first vehicle at (0, 0) or another predetermined location within the image, with its orientation aligned to face upward or another predetermined orientation. This concise yet informative representation captures the traffic flow, relative positions, and recent motion history in a form that multi-modal neural networks can intuitively interpret.

The system generates, from the data characterizing the scene, an input to the multi-modal neural network (step 204).

For example, to generate the input, the system can map the data of each modality to a respective set of tokens that can be processed by the neural network. For example, the system can map the text data describing the scene to a set of tokens by processing the text data using a text encoder, e.g., a single text embedding layer or a multi-layer neural network, e.g., a recurrent neural network or a Transformer neural, network. As another example, the system can map the image data to a set of tokens by processing the data using an image encoder neural network, e.g., a convolutional neural network, a vision Transformer neural network, or a neural network that includes both convolutional and attention layers. These neural networks can be trained jointly with the multi-modal neural network or can be pre-trained, e.g., through unsupervised representation learning, and then held fixed during the training of the multi-modal neural network.

The system can then generate an input sequence that includes the respective sets of tokens of the multiple modalities.

A “token” as used in this specification can be (i) a discrete token that represents one of a discrete set of elements in a vocabulary, e.g., is a one-hot representation of one of the elements or a unique identifier for one of the elements or (ii) a continuous token, e.g., a vector of numerical values that has a specified dimensionality, e.g., that is in a specified embedding space.

The system processes the input using the multi-modal neural network to generate an output sequence of tokens (step 206). Each token in the output sequence is from a vocabulary of tokens that includes, e.g., tokens representing one or more of words, sub-words, word pieces, characters, numbers, punctuation marks, and so on. That is, each token in the output sequence can be a discrete token that represents one of the elements in a vocabulary that includes one or more of words, sub-words, word pieces, characters, numbers, punctuation marks, and so on.

The multi-modal neural network can have any appropriate architecture for mapping an input that includes respective sets of tokens of multiple modalities to an output sequence of tokens. Examples of such architectures include the Pali-3 architecture, the PaliGemma architecture, the Gemini architecture, the Flamingo architecture, and so on. More generally, the multi-modal neural network can have any appropriate vision-language model neural network (VLM) architecture.

The system then generates, from the output sequence of tokens, trajectory data defining a planned trajectory for the first vehicle after the first time point (step 208).

For example, the system can parse the sequence of tokens to generate a respective waypoint location for each of a plurality of future time points in the planned trajectory. For example, the output sequence of tokens can include tokens representing the respective waypoint locations separated by a designated token, e.g., the “and” token or another appropriate token. Each waypoint location can be represented by one set of one or more tokens representing the x-coordinate of the waypoint location, a delimiter token, e.g., a token representing a comma or other designated symbol, and then another set one or more tokens representing the y-coordinate of the waypoint location.

The system applies a reward function to the trajectory data to determine a respective reward for each of a plurality of tokens in the output sequence (step 210).

Generally, the respective reward for a given token is a score that represents the quality of the portion of the trajectory represented by the token as measured by a set of one or more driving objectives. Examples of driving objectives include any of: collision avoidance; off-road avoidance; passenger comfort; or traffic rule compliance.

The collision avoidance objective is satisfied when the vehicle does not collide with (“overlap” with) any other agents in the environment during the trajectory.

The off-road avoidance objective is satisfied when the vehicle does not leave the roadway at any waypoint during the trajectory.

The passenger comfort objective is satisfied when passenger comfort is maximized.

The traffic rule compliance objective is satisfied when the vehicle does not violate any traffic rules during the trajectory.

For example, the reward function can include one or more terms that each correspond to a different driving objective.

For example, the term corresponding to the collision avoidance objective can have a value of negative one when the vehicle overlaps with another agent at a given waypoint location and a value of zero or positive one when the vehicle does not.

For example, the term corresponding to the off-road avoidance objective can have a value of negative one when the vehicle is off the roadway at a given waypoint location and a value of zero or positive one when the vehicle is not.

For example, the term corresponding to the passenger comfort objective can have a value that is directly proportional to the predicted level of comfort of the passenger at a given waypoint location.

For example, the term corresponding to the traffic rule compliance objective can have a value of negative one when the vehicle is violating one or more traffic rules at a given waypoint location and a value of zero or positive one when the vehicle is not.

For example, the reward function can include one or more terms that each correspond to a different driving objective. When there are multiple objectives, the reward function can be a weighted sum of the terms corresponding to the multiple objectives.

Thus, to apply the reward function to determine a respective reward value for each of the waypoint locations, the system can, for each term, determine a reward score that measures a degree to which the planned trajectory satisfies the corresponding driving objective as of the waypoint location. The system can then combine the reward scores for the terms to determine the respective reward value for the waypoint location, e.g., by computing a weighted sum of the reward scores.

For example, as will be described in more detail below, the system can determine a respective reward value for each of the waypoint locations in the trajectory and associate the reward with one or more of the respective set of tokens representing the waypoint location. As a particular example, when the waypoint locations are represented as described above, the system can associate the reward score with the last token in the set of tokens representing the waypoint location, e.g., the token before the designated token that separates the tokens representing the waypoint location from the tokens representing the next waypoint location or, for the last waypoint location, the last token in the output sequence or the token immediately preceding an end-of-sequence token in the output sequence.

The system then trains the multi-modal neural network using the respective rewards for the plurality of tokens through reinforcement learning (step 212). For example, the system can train the multi-neural network on the respective rewards using a policy gradient reinforcement learning technique. One example of such a technique is the REINFORCE algorithm. For example, the system can maximize the expected return as follows:

$${max}_{πθ} 𝔼 \text{?}$$

$$\text{?} \text{indicates text missing or illegible when filed}$$

where T is the total number of tokens (“time steps”) in the output sequence, π_{θ} is the multi-modal neural network, sₜ is the input to the multi-modal neural network when generating the token αₜ at time step t, πθ(αₜsₜ) is the probability assigned to the token αₜ by processing the input sₜ by the multi-modal neural network, and \tilde{Q}_{π}(sₜ, αₜ) is the empirical return obtained starting from time step t until the end of the trajectory, e.g., the sum of rewards for time steps starting from t (referred to as the “reward-to-go”) or a time-discounted sum of rewards for time steps starting from t. As another example, the system can maximize the expected return subject to a KL-divergence regularization between the multi-modal neural network and a reference multi-modal neural network C, e.g., the multi-modal neural network prior to reinforcement learning training or prior to supervised fine-tuning:

$${max}_{πθ} 𝔼 \text{?}$$

$$\text{?} \text{indicates text missing or illegible when filed}$$

where α is positive constant value, V_{φ}(sₜ) is a value estimate for the input sₜ, e.g., a learned value estimate or a computed value estimate, and D_{KL} represents the KL divergence. By training the neural network in this manner, the system optimizes for the true planning objectives rather than focusing solely on token prediction accuracy, enabling the neural network to refine its understanding of the planning task beyond simple imitation. In particular, this type of training provides the neural network information about the multi-step consequences and the alignment with crucial planning considerations of outputting a given token at any given position in the output sequence.

The system can perform multiple different iterations of the process 200 on different scene data in order to effectively train the multi-modal neural network through reinforcement learning.

In some implementations, after training the multi-modal neural network as described in the example 200, the system deploys the multi-modal neural network on-board an autonomous vehicle for planning motion of the autonomous vehicle. That is, an on-board system of the autonomous vehicle can control the autonomous vehicle using motion plans generated by the multi-modal neural network as described above with reference to FIG. 1.

In some other implementations, the multi-modal neural network can be too large to effectively be used on-board the autonomous vehicle, e.g., because the multi-modal neural network has too many parameters to generate motion plans with less than a maximum permissible latency. In these implementations, after training the multi-modal neural network, the system can train, using the multi-modal neural network and through distillation, a motion planning neural network for planning motion of an autonomous vehicle. The motion planning neural network is a smaller neural network, i.e., having fewer parameters, that is also configured to generate motion plans. After training the motion planning neural network, the system can deploy the motion planning neural network on-board the autonomous vehicle for planning motion of the autonomous vehicle. That is, an on-board system of the autonomous vehicles can control the autonomous vehicle using motion plans generated by the motion planning neural network as described above with reference to FIG. 1.

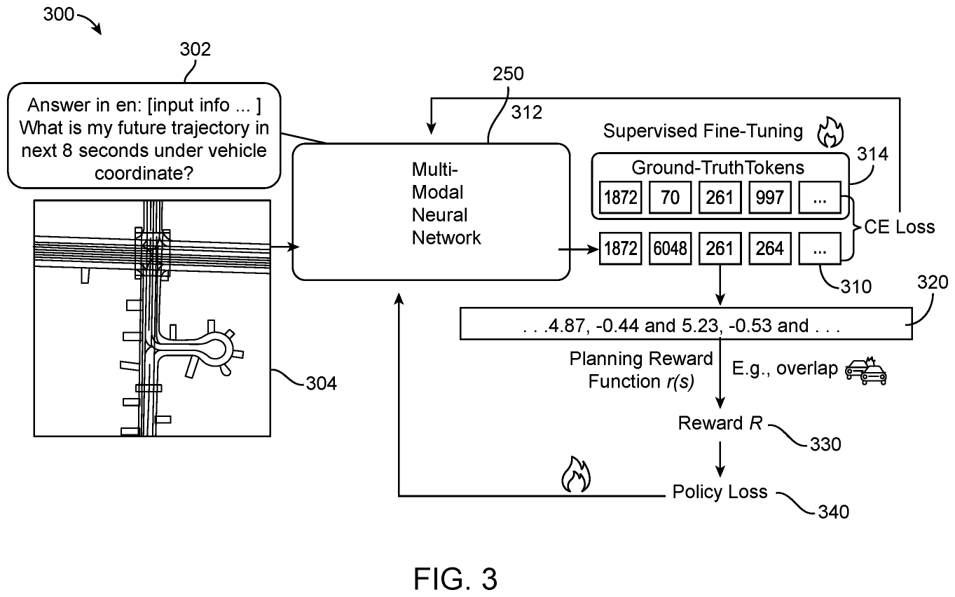

FIG. 3 shows an example 300 of the reinforcement learning training of the multi-modal neural network 250.

As described above, the multi-modal neural network 250 processes an input generated from data characterizing a scene in an environment being navigated by a first vehicle at a first time point.

In particular, the example 300 shows an input that includes textual data 302 and image data 304 being provided as input to the multi-modal neural network 250. More specifically, the multi-modal neural network 250 processes the input to generate an output sequence of tokens 310 that represents a motion plan for an autonomous vehicle.

For example, the multi-modal neural network 250 can include a vision encoder that encodes the image data 304 into a set of tokens and a text encoder that encodes the textual data 302 into a set of tokens. For example, the vision encoder can be a Vision Transformer neural network, a convolutional neural network, or a neural network that has both attention and convolutional layers. As another example, the text encoder can be a single text embedding layer, Transformer neural network, a recurrent neural network, or a neural network that has both attention and recurrent layers.

The multi-modal neural network 250 then generates a sequence of tokens that represents the scene from the tokens corresponding to the image data 304 and the tokens corresponding to the textual data and processes the sequence of tokens to generate the output sequence 310. For example, the multi-modal neural network 250 can include an auto-regressive Transformer decoder neural network, a recurrent neural network, or a neural network that includes both recurrent and attention layers.

As shown in the example 300, a system that performs supervised fine-tuning (SFT) would leverage a ground truth output sequence 314 to determine a cross-entropy (CE) loss and then use gradients of the CE loss to train the multi-modal neural network 250.

Instead, the system generates, from the output sequence of tokens 310, trajectory data 320 defining a planned trajectory for the first vehicle after the first time point. For example, the system can parse the sequence of tokens 310 to generate a respective waypoint location 322 for each of a plurality of future time points in the planned trajectory.

The system then applies a reward function 330 to the trajectory data 320 to determine a respective reward for each of a plurality of tokens in the output sequence and then trains the multi-modal neural network 250 using the respective rewards for the plurality of tokens through reinforcement learning.

For example, the system can apply a policy gradient technique to minimize a policy loss 340, e.g., one of the example losses described above with reference to FIG. 2, to update the parameters of the neural network 250.

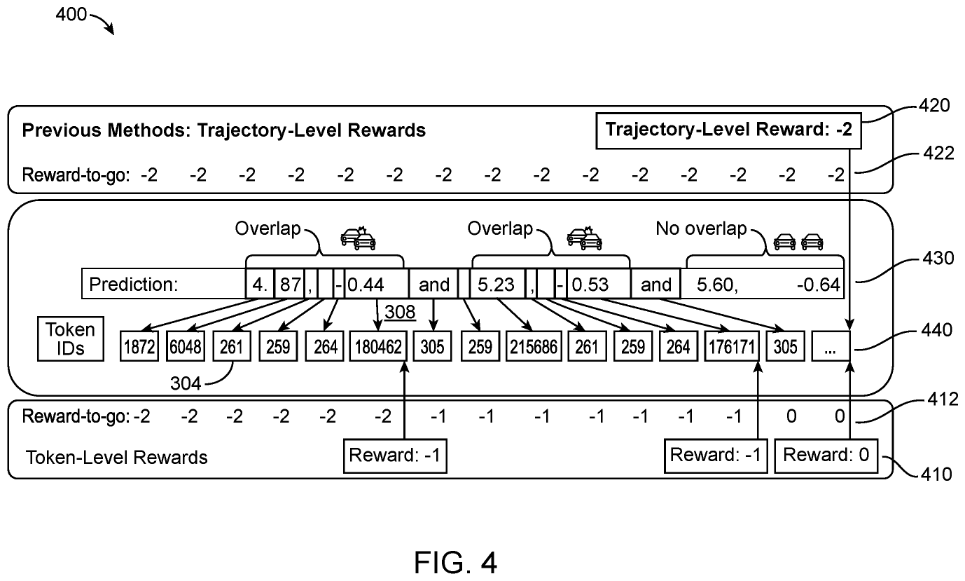

FIG. 4 shows an example 400 of the rewards used by the described techniques relative to those used by other approaches.

In particular, the example 400 shows rewards 410 and rewards-to-go 412 computed using the described techniques relative to rewards 420 and rewards-to-go 422 computed using a technique that assigns trajectory-level rewards.

More specifically, in the example 400, the neural network 250 generates an output sequence 430 that defines a trajectory 440 that includes three waypoints: (4.87, −0.44), (5.23, −0.53), and (5.60, −0.64). More specifically, the neural network 250 generates an output sequence 430 that includes tokens representing coordinates for each waypoint location separated by a token that represents a comma, with each waypoint being separated by a token representing “and.”

In the example 400, the reward function measures overlap between the vehicle for which the trajectory 440 is being generated and other vehicles in the scene. As can be seen from the example 400, at the first and second waypoint locations an overlap exists, while at the third waypoint location, no overlap exists.

In the trajectory-level reward technique, a single reward 420 would be assigned that measures the overall quality of the trajectory. In the example 400, the single reward 420 is −2 because there were two waypoints where an overlap existed and the reward function assigns a reward equal to the negative of the number of waypoint locations where overlap occurred. Thus, the reward-to-go 422 is the same, −2, for each token in the output sequence 430.

Using the described techniques, however, the system assigns a respective reward to the last token corresponding to each waypoint in the trajectory. Thus, the system assigns a reward of −1 to the token 180462 because an overlap existed at the first waypoint location, a reward of −1 to the token 176171 because an overlap existed at the second waypoint location, and a reward of 0 to the last token in the output sequence because no overlap existed at the third waypoint location. Then, as can be seen from the example 400, the reward-to-go 412 is different for different tokens in the output sequence 430. This approach captures the impacts of key tokens on the objective, enabling more precise credit assignment.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
obtaining data characterizing a scene in an environment being navigated by a first vehicle at a first time point;
generating, from the data characterizing the scene, an input to a multi-modal neural network;
processing the input using the multi-modal neural network to generate an output sequence of tokens;
generating, from the output sequence of tokens, trajectory data defining a planned trajectory for the first vehicle after the first time point;
applying a reward function to the trajectory data to determine a respective reward for each of a plurality of tokens in the output sequence; and
training the multi-modal neural network using the respective rewards for the plurality of tokens through reinforcement learning.

2. The method of claim 1, further comprising, after training the multi-modal neural network:
deploying the multi-modal neural network on-board an autonomous vehicle for planning motion of the autonomous vehicle.

3. The method of claim 2, further comprising:
controlling the autonomous vehicle using motion plans generated by the multi-modal neural network.

4. The method of claim 1, further comprising, after training the multi-modal neural network:
training, using the multi-modal neural network and through distillation, a motion planning neural network for planning motion of an autonomous vehicle.

5. The method of claim 4, further comprising, after training the motion planning neural network:
deploying the motion planning neural network on-board the autonomous vehicle for planning motion of the autonomous vehicle.

6. The method of claim 4, further comprising:
controlling the autonomous vehicle using motion plans generated by the motion planning neural network.

7. The method of claim 1, wherein generating, from the data characterizing the scene, an input to a multi-modal neural network comprises generating an input sequence of tokens that represents the scene.

8. The method of claim 1, further comprising:
obtaining route data identifying an intended route for the first vehicle after the first time point, and wherein:
generating, from the data characterizing the scene, an input to the multi-modal neural network comprises generating, from the data characterizing the scene and the route data, the input to the multi-modal neural network.

9. The method of claim 1, wherein the data characterizing the scene comprises data captured by one or more sensors of the first vehicle.

10. The method of claim 1, wherein the data characterizing the scene comprises road graph data.

11. The method of claim 1, wherein the data characterizing the scene comprises data characterizing other agents in the scene.

12. The method of claim 1, wherein the data characterizing the scene comprises two or more of: text data, image data, LiDAR data, radar data, or audio data.

13. The method of claim 1, wherein the multi-modal neural network has been pre-trained one or more pre-training tasks.

14. The method of claim 1, wherein:
the trajectory data comprises a respective waypoint location at each of a plurality of time points, and
applying a reward function to the trajectory data to determine a respective reward for each of a plurality of tokens in the output sequence comprises:
applying the reward function to determine a respective reward value for each of the waypoint locations.

15. The method of claim 14, wherein the output sequence comprises a respective set of tokens representing each of the respective waypoint locations, and wherein applying a reward function to the trajectory data to determine a respective reward for each of a plurality of tokens in the output sequence comprises, for each waypoint location, associating the respective reward value for the waypoint location with one or more of the tokens in the respective set of tokens representing the waypoint location.

16. The method of claim 14, wherein the reward function comprises one or more terms that each correspond to a different driving objective.

17. The method of claim 16, wherein applying the reward function to determine a respective reward value for each of the waypoint locations comprises:
for each of the one or more terms, determining a reward score that measures a degree to which the planned trajectory satisfies the corresponding driving objective as of the waypoint location; and
combining the reward scores for the terms to determine the respective reward value for the waypoint location.

18. The method of claim 16, wherein the one or more driving objectives comprise one or more of:
collision avoidance;
off-road avoidance;
passenger comfort; or
traffic rule compliance.

19. A system comprising:
one or more computers; and
one or more storage devices storing instructions that, when executed by the one or more computers, cause the one or more computers to perform operations comprising:
obtaining data characterizing a scene in an environment being navigated by a first vehicle at a first time point;
generating, from the data characterizing the scene, an input to a multi-modal neural network;
processing the input using the multi-modal neural network to generate an output sequence of tokens;
generating, from the output sequence of tokens, trajectory data defining a planned trajectory for the first vehicle after the first time point;
applying a reward function to the trajectory data to determine a respective reward for each of a plurality of tokens in the output sequence; and
training the multi-modal neural network using the respective rewards for the plurality of tokens through reinforcement learning.

20. One or more non-transitory computer-readable storage media storing instructions that when executed by one or more computers cause the one or more computers to perform operations comprising:
obtaining data characterizing a scene in an environment being navigated by a first vehicle at a first time point;
generating, from the data characterizing the scene, an input to a multi-modal neural network;
processing the input using the multi-modal neural network to generate an output sequence of tokens;
generating, from the output sequence of tokens, trajectory data defining a planned trajectory for the first vehicle after the first time point;
applying a reward function to the trajectory data to determine a respective reward for each of a plurality of tokens in the output sequence; and
training the multi-modal neural network using the respective rewards for the plurality of tokens through reinforcement learning.
